(19) United States
(12) Patent Application Publication
(10) Pub. No.: US 2025/0345753 A1
(43) Pub. Date: Nov. 13, 2025

(54) SOLAR SEAWATER DESALINATION MEMBRANE, PREPARATION METHOD AND SEAWATER DESALINATION TREATMENT METHOD THEREOF

(71) Applicant: University of Science and Technology Beijing, Beijing (CN)

(72) Inventors: Yue ZHANG, Beijing (CN); Zhaozhao XIONG, Beijing (CN); Zhuo KANG, Beijing (CN); Yuchen WANG, Beijing (CN); Shuang HU, Beijing (CN); Xing XIE, Beijing (CN); Hui HAO, Beijing (CN); Wenfei LI, Beijing (CN)

(21) Appl. No.: 18/910,417

(22) Filed: Oct. 9, 2024

(30) Foreign Application Priority Data
May 7, 2024 (CN) 202410550730.2

(51) Int. Cl. B01D 67/00; B01D 61/36; B01D 69/02; B01D 69/10; B01D 69/14; B01D 71/02; B01D 71/60; C02F 1/44; C02F 103/08

(52) U.S. Cl. CPC B01D 67/0079; B01D 61/362; B01D 67/0095; B01D 69/02; B01D 69/105; B01D 69/108; B01D 69/141; B01D 71/021; B01D 71/60; C02F 1/448; B01D 2323/02; B01D 2323/082; B01D 2323/219; B01D 2323/56; B01D 2325/36; C02F 2103/08

(57) ABSTRACT

Disclosed are a solar seawater desalination membrane, a preparation method and a seawater desalination treatment method thereof. The preparation method includes: carrying out hydrophilic treatment on a first carbon cloth to obtain a second carbon cloth with hydrophilicity greater than that of the first carbon cloth; an average pore size of the second carbon cloth is of micron-scale; carrying out a coating treatment on the second carbon cloth based on a preset copper mesh to obtain a first cloth membrane; processing the first cloth membrane to obtain a second cloth membrane; the second cloth membrane includes a graphdiyne structure and the average pore size of the second cloth membrane is of nanometer-scale; processing the second cloth membrane to obtain the solar seawater desalination membrane. The solar seawater desalination membrane contains poly-dopamine particles, and the average pore size of the membrane is smaller than that of the second cloth membrane.

### CROSS-REFERENCE TO RELATED APPLICATIONS

This application claims priority to Chinese Patent Application No. 202410550730.2, filed on May 7, 2024, the contents of which are hereby incorporated by reference.

### TECHNICAL FIELD

The present disclosure relates to the technical field of solar seawater desalination, and in particular to a solar seawater desalination membrane, a preparation method and a seawater desalination treatment method thereof.

### BACKGROUND

Solar interface evaporation is one of the most promising technologies for solving the shortage of freshwater resources that has seriously threatened ecological and human development. The efficiency of solar evaporation depends largely on the absorber, where solar energy is converted into thermal energy to evaporate water.

In the process of photothermal desalination, a three-dimensional crosslinked pore structure provides a channel for water to be transported from the water body to the interface, as well as providing a pathway for vapor to escape. However, the photothermal evaporator material in the prior art has limited application in the field of seawater desalination in that the too-large holes in the upper layer of the photothermal evaporator material result in more heat dissipation to the water body below, resulting in a poor thermal localization effect, and too small holes in the lower layer of the photothermal evaporator material limit upward transmission of the water below. Moreover, in desalination and wastewater treatment processes, the presence of heavy metal salt ions reduces the stability of the evaporator and contaminates the quality of the produced water.

### SUMMARY

In view of this, the embodiments of the present disclosure provide a solar seawater desalination membrane, a preparation method and a seawater desalination treatment method thereof, with capability of solving the problems of low seawater desalination efficiency, high heat dissipation loss, water quality pollution and the like existing in the prior art.

An aspect of the embodiments of the present disclosure provides a solar seawater desalination membrane, including:
carbon cloth, where the carbon cloth includes a plurality of fibrous structures, and an average pore size on the carbon cloth is of micron-scale;
graphdiyne structure attached to one side of the carbon cloth, where the graphdiyne structure includes a plurality of graphdiyne nanosheets interwoven with each other; and an average pore size of the graphdiyne structure is of nanometer-scale; and a plurality of poly-dopamine particles attached to the graphdiyne nanosheets;
where an average pore size of the poly-dopamine particles is of nanometer-scale, and the average pore size of the poly-dopamine particles is smaller than the average pore size of the graphdiyne structure.

Optionally, the carbon cloth is a hydrophilic modified carbon cloth.

Optionally, the poly-dopamine particles have a spherical structure.

In another aspect, the embodiments of the present disclosure provide a preparation of the solar seawater desalination membrane, including the following steps:
carrying out a hydrophilic treatment on a first carbon cloth to obtain a second carbon cloth, where a hydrophilicity of the second carbon cloth is greater than a hydrophilicity of the first carbon cloth, and an average pore size of the second carbon cloth is of micron-scale;
carrying out a coating treatment on the second carbon cloth based on a preset copper mesh to obtain a first cloth membrane;
processing the first cloth membrane to obtain a second cloth membrane, wherein the second cloth membrane includes the graphdiyne structure, and an average pore size of the second cloth membrane is of nanometer-scale; and
processing the second cloth membrane to obtain a solar seawater desalination membrane;
where the solar seawater desalination membrane includes the poly-dopamine particles, and an average pore size of the solar seawater desalination membrane is smaller than the average pore size of the second cloth membrane.

Optionally, carrying out the hydrophilic treatment on the first carbon cloth to obtain the second carbon cloth includes:
placing the first carbon cloth in a cleaning solution, and performing ultrasonic cleaning for a first preset duration;
carrying out hydrophilic treatment on the first carbon cloth after the ultrasonic cleaning by adopting a first solution; and
washing the first carbon cloth after the hydrophilic treatment in deionized water and carrying out drying treatment to obtain the second carbon cloth.

Optionally, the first carbon cloth is a raw carbon cloth; and
a pore size of the raw carbon cloth is D1, where 1 micrometer (μm)≤D1≤10 μm;
the first preset duration is t1, and 5 minutes (min)≤t1; and
the first solution is a strong acid solution.

Optionally, carrying out the coating treatment on the second carbon cloth based on the preset copper mesh to obtain the first cloth membrane includes:
carrying out electrochemical polishing on the preset copper mesh;
cleaning the preset copper mesh after the polishing;
drying the preset copper mesh after the cleaning under the nitrogen flow; and
coating the preset copper mesh after the drying on either side of the second carbon cloth to obtain the first cloth membrane.

Optionally, processing the first cloth membrane to obtain the second cloth membrane includes:
obtaining a preset graphdiyne monomer-acetone solution;
putting a second solution into a first reaction container, where the second solution includes acetone, pyridine and N,N,N′,N′-tetramethylethylenediamine (TMEDA);
placing the first cloth membrane in the second solution;
dropping the preset graphdiyne monomer-acetone solution into the second solution at a preset flow rate under a preset condition;
standing for a second preset duration according to a preset temperature to obtain a graphdiyne cloth membrane;
taking out the graphdiyne cloth membrane and cleaning the graphdiyne cloth membrane in a preset state; and
drying the graphdiyne cloth membrane after the cleaning under a nitrogen flow to obtain the second cloth membrane.

Optionally, a method for obtaining the preset graphdiyne monomer-acetone solution includes the following steps:
placing tetrahydrofuran of a first preset amount in a second reaction container;
dissolving hexakis (trimethylsilyl ethynyl)benzene of a second preset amount in the second reaction container under an argon atmosphere;
ice bathing the second reaction container according to a third preset duration;
adding tetrabutylammonium fluoride of a third preset amount into the second reaction container after the ice bathing;
standing in a dark for a fourth preset duration;
mixing saturated saline solution into the second reaction container, standing for liquid
separation, and obtaining a lower layer solution in the second reaction container;
performing an extraction operation on the lower layer solution to obtain a target solution;
performing rotary steaming on the target solution to obtain a target powder; and
dissolving the target powder in acetone of a fourth preset amount to obtain the preset graphdiyne monomer-acetone solution.

Optionally, processing the second cloth membrane to obtain the solar seawater desalination membrane includes:
placing the second cloth membrane in a third solution;
where the third solution includes dopamine hydrochloride and a buffer solution;
stirring the third solution for the fourth preset duration in a ventilated state to obtain a third cloth membrane, where the poly-dopamine particles are attached to the third cloth membrane;
taking out the third cloth membrane after the stirring;
cleaning and drying the third cloth membrane after the stirring; and
dismantling the preset copper mesh to obtain the solar seawater desalination membrane.

Another aspect of the embodiments of the present disclosure provides a seawater desalination treatment method, including using the solar seawater desalination membrane or the solar seawater desalination membrane prepared by the preparation method of the solar seawater desalination membrane to carry out seawater desalination treatment.

According to the preparation method of the solar seawater desalination membrane disclosed by the present disclosure, the second carbon cloth obtained by treating the first carbon cloth has higher hydrophilicity, which facilitates the penetration of water molecules, provides a large number of channels for water transmission, and effectively improves the efficiency of seawater desalination; the second cloth membrane is obtained by growing a graphdiyne structure in a hydrophilic carbon cloth, i.e., the second cloth membrane has graphdiyne attached to the fibers of the carbon cloth, so that the second cloth membrane has a low thermal conductivity, which prevents heat dissipation effectively and improves energy utilization, that is, the efficiency of photothermal conversion is effectively enhanced, and the efficiency of solar desalination is improved; the solar seawater desalination membrane with good hydrophilicity and high conversion efficiency is be obtained by polymerization of dopamine; by growing a solar seawater desalination membrane with decreasing pore size from bottom to top, the large holes in the lower layer of carbon cloth maintain the super capillary effect of three-dimensional hole structure, which may quickly replenish water from below; the secondary holes in the upper layer of graphdiyne and poly-dopamine inhibit the dissipation of heat to the lower water body; and the intrinsic low thermal conductivity of graphdiyne itself inhibits the dissipation of surface heat to the outside air, so that the heat is concentrated on the evaporation surface, showing a high thermal localization effect.

The above description is only an overview of the technical scheme of the present disclosure, which may be implemented according to the contents of the specification in order to understand the technical means of the present disclosure more clearly, and to make the above and other purposes, features and advantages of the present disclosure more obvious and understandable, the following is a detailed description of preferred embodiments with the accompanying drawings.

### BRIEF DESCRIPTION OF THE DRAWINGS

In order to explain the technical schemes of the embodiments of the present disclosure more clearly, the drawings needed in the embodiments are briefly introduced below. Obviously, the drawings described below are only some embodiments of the present disclosure, and other drawings can be obtained according to these drawings without creative work for ordinary people in the field.

FIG. 1 is a flowchart of a preparation method of a solar seawater desalination membrane provided by an embodiment of the present disclosure.

FIG. 2 is a flowchart of a method for obtaining a second carbon cloth in FIG. 1.

FIG. 3 is a flowchart of a method for obtaining a first cloth membrane in FIG. 1.

FIG. 4 is a flowchart of a method for obtaining a second cloth membrane in FIG. 1.

FIG. 5 is a flowchart of a method for obtaining a preset graphdiyne monomer-acetone solution in FIG. 4.

FIG. 6 is a flowchart of a method for processing the second cloth membrane in FIG. 1.

FIG. 7 is a schematic cross-sectional view of the second carbon cloth in FIG. 1.

FIG. 8 is a schematic cross-sectional view of the first cloth membrane in FIG. 1.

FIG. 9 is a schematic cross-sectional view of the second cloth membrane in FIG. 1.

FIG. 10 is a schematic cross-sectional view of a third cloth membrane in FIG. 1.

FIG. 11A is an electron microscope diagram with a scale of 500 μm of the second carbon cloth.

FIG. 11B is an electron microscope diagram with a scale of 50 μm of the second carbon cloth.

FIG. 12A is an electron microscope diagram with a scale of 50 μm of a second cloth membrane.

FIG. 12B is an electron microscope diagram with a scale of 5 μm of a second cloth membrane.

FIG. 13A is an electron microscope diagram with a scale of 50 μm of the solar seawater desalination membrane.

FIG. 13B is an electron microscope diagram with a scale of 5 μm of the solar seawater desalination membrane.

FIG. 14 is a Raman spectrum diagram of the second cloth membrane provided by the embodiment of the present disclosure.

FIG. 15 is a schematic diagram for comparing ion concentrations of water before and after evaporation of the solar seawater desalination membrane provided by the embodiment of the present disclosure.

FIG. 16 is a schematic diagram for comparing the ion concentrations of water before and after evaporation of the solar seawater desalination membrane provided by the embodiment of the present disclosure in the state of heavy metal wastewater.

FIG. 17 is a schematic cross-sectional view of the solar seawater desalination membrane provided by the embodiment of the present disclosure.

### DETAILED DESCRIPTION OF THE EMBODIMENTS

The embodiments of the present disclosure are described in detail with reference to the accompanying drawings.

It should be clear that the embodiments of the present disclosure are described below through specific examples, and those skilled in the art may easily understand other advantages and effects of the present disclosure from the contents disclosed in this specification. Obviously, the described embodiment is only a part of the embodiment of the present disclosure, not the whole embodiment. This disclosure may also be implemented or applied through different specific embodiments, and various details in this specification may be modified or changed based on different viewpoints and applications without departing from the spirit of this disclosure. It should be noted that the following embodiments and features in the embodiments may be combined with each other without conflict. Based on the embodiments in this disclosure, all other embodiments obtained by ordinary technicians in this field without creative work belong to the protection scope of this disclosure.

It should be noted that various aspects of the embodiments within the scope of the appended claims are described below. It should be obvious that the aspects described herein may be embodied in a wide variety of forms, and any specific structure and/or function described herein is merely illustrative. Based on this disclosure, those skilled in the art should understand that one aspect described herein may be implemented independently of any other aspect, and two or more of these aspects may be combined in various ways. For example, devices and/or practice methods may be implemented using any number of aspects set forth herein. In addition, the apparatus and/or the method may be implemented using other structures and/or functionalities than one or more of the aspects set forth herein.

It should also be noted that the diagrams provided in the following examples only illustrate the basic concept of this disclosure in a schematic way, and only the components related to this disclosure are shown in the diagrams, which are not drawn according to the number, shape and size of components in actual implementation. In actual implementation, the type, quantity and proportion of components may be changed at will, and the layout of components may be more complicated.

In addition, in the following description, specific details are provided to facilitate a thorough understanding of the examples. However, it will be understood by those skilled in the art that the described aspects may be practiced without these specific details.

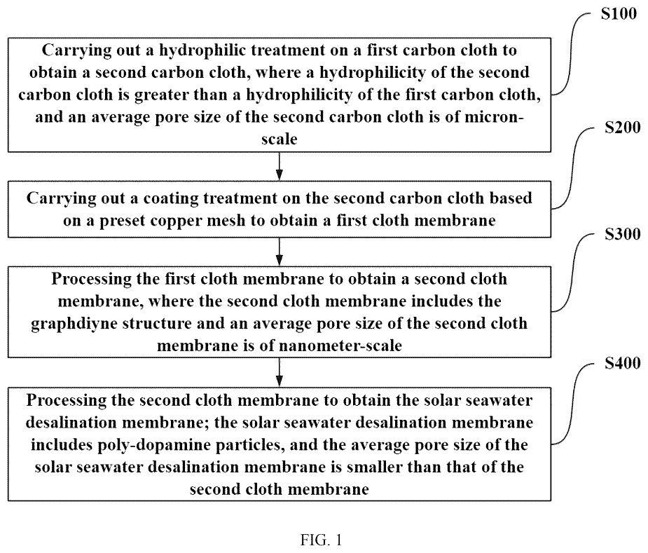

Referring to FIG. 1, an aspect of the application discloses a preparation method of a solar seawater desalination membrane, which specifically includes the following steps:
S100: carrying out a hydrophilic treatment on a first carbon cloth to obtain a second carbon cloth, where a hydrophilicity of the second carbon cloth is greater than a hydrophilicity of the first carbon cloth, and an average pore size of the second carbon cloth is of micron-scale; and
the first carbon cloth is the base carbon cloth, and hydrophilic modification of the base carbon cloth may enhance water transport and increase water vapor production;
S200: carrying out a coating treatment on the second carbon cloth based on a preset copper mesh to obtain a first cloth membrane;
S300: processing the first cloth membrane to obtain a second cloth membrane, where the second cloth membrane includes the graphdiyne structure and an average pore size of the second cloth membrane is of nanometer-scale; and this step is to grow graphdiyne structure;
through this step, the graphdiyne structure is grown on the first cloth membrane, that is, the graphdiyne nano-wall is grown on the obtained second cloth membrane;
optionally, the graphdiyne structure includes a plurality of graphdiyne nanosheets interwoven with each other, and a plurality of graphdiyne nano-plates interwoven with each other in three dimensions to form a three-dimensional graphdiyne structure;
S400: processing the second cloth membrane to obtain the solar seawater desalination membrane; the solar seawater desalination membrane includes poly-dopamine particles, and the average pore size of the solar seawater desalination membrane is smaller than that of the second cloth membrane.

Optionally, the solar seawater desalination membrane includes a plurality of poly-dopamine particles of spherical structure, and the poly-dopamine particles are attached to the graphdiyne nano-wall (i.e. graphdiyne structure), specifically, a plurality of poly-dopamine particles are attached to a plurality of graphdiyne nano-plates. Naturally, there are also poly-dopamine particles that inevitably adhere to the second cloth membrane.

According to the preparation method of the solar seawater desalination membrane disclosed by the present disclosure, the second carbon cloth obtained by treating the first carbon cloth has higher hydrophilicity, which facilitates the penetration of water molecules, provides a large number of channels for water transmission, and therefore effectively improves the efficiency of seawater desalination; the second cloth membrane is obtained by growing graphdiyne structure on hydrophilic carbon cloth, i.e., the carbon fiber of the second cloth membrane is attached with graphdiyne, so that the second cloth membrane has a low thermal conductivity, which may effectively inhibit the heat dissipation and improve the energy utilization, in other words, the photothermal conversion efficiency may be effectively enhanced to increase the efficiency of the solar energy seawater desalination; and the solar seawater desalination membrane with good hydrophilicity and high conversion efficiency may be obtained by treatment of poly-dopamine. By growing layers of solar seawater desalination membranes with decreasing pore sizes from bottom to top, the large pores of the carbon cloth at lower layer maintain the super capillary effect of the three-dimensional pore structure to rapidly replenish the water from below, the secondary pores of the upper graphdiyne and polydopamine inhibit the dissipation of heat to the water below, and the intrinsic property of low thermal conductivity of the graphdiyne inhibits the dissipation of the surface heat to the outside air, which concentrates the heat on the evaporating surface, demonstrating a high thermal localization effect.

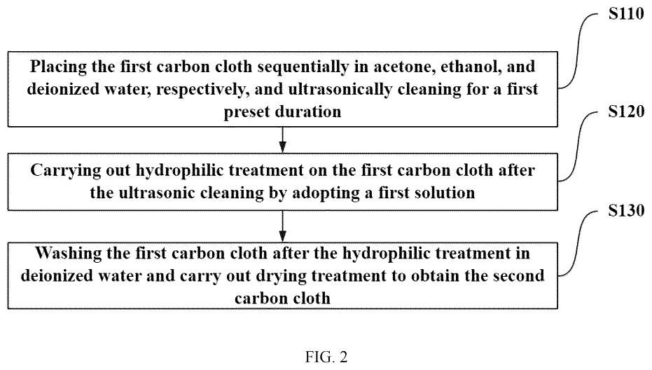

Referring to FIG. 2, a method for obtaining the second carbon cloth in FIG. 1 specifically includes:
S110: placing the first carbon cloth sequentially in acetone, ethanol, and deionized water, respectively, and ultrasonically cleaning for a first preset duration;
in this step, acetone, ethanol and deionized water constitute a cleaning solution;
through ultrasonic cleaning, the organic matter and other impurities in the first carbon cloth are removed, and a pure carbon cloth is obtained; specifically, the organic matter in the first carbon cloth is removed by acetone, the acetone is removed by ethanol, and the ethanol and other impurities are removed by deionized water;
S120: carrying out hydrophilic treatment on the first carbon cloth after the ultrasonic cleaning by adopting a first solution;
the first solution is preferably a strong acid solution;
optionally, the first solution includes nitric acid and sulfuric acid with a stoichiometric ratio of 3:1; and the objective of treating pure carbon cloth with this first solution is to improve its hydrophilicity;
in this step, the first carbon cloth after ultrasonic cleaning may be put into the strong acid solution for 24 hours (h) to ensure that the hydrophilic treatment meets the requirements; and
S130: washing the first carbon cloth after the hydrophilic treatment in deionized water and carrying out drying treatment to obtain the second carbon cloth.

The second carbon cloth is a water conveyance sublayer-hydrophilic modified carbon cloth.

In this embodiment, by hydrophilic treatment, the surface of the cleaned first carbon cloth may be made hydrophilic to improve the adsorption performance or other properties; and by standardizing the treatment steps, the second carbon cloth obtained in each batch may be ensured to have consistent performance and quality.

In this embodiment, the first carbon cloth is preferably made of raw carbon cloth.

A pore size of the raw carbon cloth is D1, where 1 μm≤D1≤10 μm.

the first preset duration is t1, and 5 min≤t1; or 5 min≤t1≤30 min, with an objective to clean the first carbon cloth.

Among them, a duration of hydrophilic treatment is not less than 24 h.

In this embodiment, an oven may be used for drying.

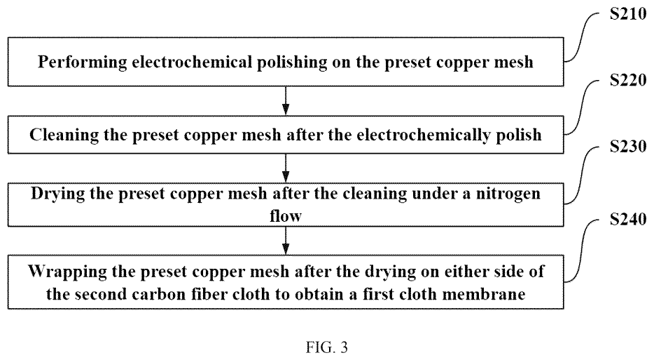

Referring to FIG. 3, a method for obtaining the first cloth membrane includes:
S210: performing electrochemical polishing on the preset copper mesh;
specifically, a mixed solution of phosphoric acid and ethanol is used to electrochemically polish the preset copper mesh;
S220: cleaning the preset copper mesh after the electrochemically polish;
specifically, the impurities or chemicals that may remain on the surface are removed by continuous washing with ethanol, hydrochloric acid, and acetone for 5 min to 10 min;
S230: drying the preset copper mesh after the cleaning under a nitrogen flow;
through this step, it is helpful to prevent the occurrence of adverse reactions such as oxidation and maintain the surface state of the copper mesh; and
S240: wrapping the preset copper mesh after the drying on either side of the second carbon cloth to obtain a first cloth membrane.

Specifically, the preset copper mesh after the drying may be made into an envelope to cover any side of the second carbon cloth, that is, the peripheral side of the second carbon cloth may be covered to ensure close contact with carbon cloth, where the side covered is the side to be used.

In this embodiment, the steps of electrochemical polishing and cleaning enable the surface of the copper mesh to be more suitable for combining with the carbon cloth, thus improving the efficiency of the preparation process; the steps of cleaning and drying ensure the quality and surface state of the first cloth membrane, which is conducive to the following performance of the desalination membrane; and the use of the method of drying under the flow of nitrogen may be more environmentally friendly than the conventional method of drying in air, by which energy resources are saved.

Among them, a mesh number of the preset copper mesh is P, and 100≤P≤200;
a diameter of the copper wire of the preset copper mesh is D2, and 0.3 mm≤D2≤0.6 mm; and
a purity of the preset copper mesh is not less than 95%, so as to ensure the reaction effect.

In this embodiment, the preset copper mesh is the copper source, so as to provide Cu²⁺, which is the catalyst for graphdiyne monomer to obtain graphdiyne through acetylenic coupling reaction. The growth conditions of graphdiyne are strict, and the higher the purity of the copper mesh, the less impurities will be introduced, and the less graphdiyne by-products will be obtained. The mesh number of the copper mesh is 100-200 meshes in order to obtain the graphdiyne wall with dozens of nanometer holes.

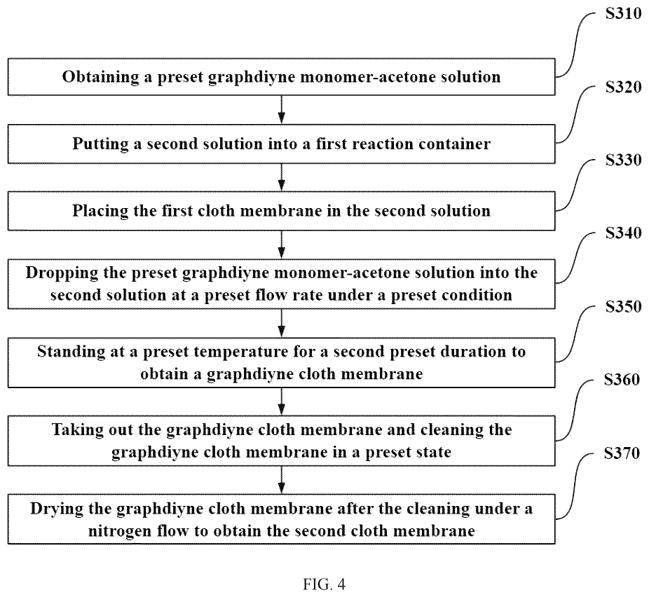

Referring to FIG. 4, a method for obtaining the second cloth membrane includes:
S310: obtaining a preset graphdiyne monomer-acetone solution;
S320: putting a second solution into a first reaction container;
among them, the second solution includes acetone, pyridine and N,N,N′,N′-tetramethylethylenediamine;
the first reaction container is preferably a three-necked flask;
among them, acetone serves to dissolve the graphdiyne monomer; pyridine provides an alkaline environment for the solution, and copper is easily converted to copper ions in the presence of pyridine; N,N,N′,N′-tetramethylethylenediamine forms a ligand complex with the copper ions to act as a mobile catalyst for the alkyne coupling reaction, and diffuses into the carbon cloth to induce the growth of graphdiyne therein;
S330: placing the first cloth membrane in the second solution;
S340: dropping the preset graphdiyne monomer-acetone solution into the second solution at a preset flow rate under a preset condition;
where the preset condition is an argon atmosphere; and the preset flow rate is preferably one drop every 20 seconds;
in the argon atmosphere, a dropping speed is controlled to be one drop every 20 seconds in the three-necked flask, and the dropping rate is controlled to be slow in order to keep the concentration of graphdiyne monomer (hexakis[(trimethylsilyl)ethynyl]benzene, or HEB for short) at a low level, so that the graphdiyne grows uniformly;
S350: standing at a preset temperature for a second preset duration to obtain a graphdiyne cloth membrane;
among them, the preset temperature is T1, and 40 degrees Celsius (° C.)≤T1≤60° C.;
the second preset duration is t2, and 13 h≤t2≤24 h, and preferably 13 h in this embodiment;
through this step, it is suitable for graphdiyne growth, and the reaction may be completed for 13 h;
S360: taking out the graphdiyne cloth membrane and cleaning the graphdiyne cloth membrane in a preset state;
where the preset state is a dark state of argon atmosphere, and the dark state is kept to prevent the graphdiyne monomer from being oxidized;
specifically, the cleaning is performed sequentially with warm acetone, N,N-dimethylformamide (DMF), ethanol, and deionized water, and the later cleaning solution is used to remove the impurities of the last introduced cleaning solution, and the cleaning solution is gradually changed from a chaotic dark green color to a clarified brown color; and in this embodiment, warm acetone is used to ensure clean washing since acetone at room temperature fails to wash away organic by-products such as alkyne-copper products or oligomeric graphdiyne; and
S370: drying the graphdiyne cloth membrane after the cleaning under a nitrogen flow to obtain the second cloth membrane.

Among them, the second cloth membrane is hydrophilic modified carbon cloth graphdiyne@CF with graphdiyne wall.

The graphdiyne nano-wall structure is grown on the surface of carbon cloth, which forms a small pore structure on the light-facing surface. Meanwhile, graphdiyne has low thermal conductivity, which suppresses heat dissipation and improves energy utilization.

In the reaction of this embodiment, the copper mesh in contact with carbon cloth is dissolved into copper ions under the influence of pyridine and N,N,N′,N′-tetramethylethylenediamine, and graphdiyne is grown in situ. As the proceeding of the reaction, graphdiyne is also grown on the carbon cloth in contact with the pore of the copper mesh, and graphdiyne will grow on the single side of carbon cloth.

In this application, the second solution is a growth solution.

Optionally, the second solution includes acetone of a first volume, pyridine of a second volume and N,N,N′,N′-tetramethylethylenediamine of a third volume

The first volume is V1, 80 mL≤V1≤120 mL;
the second volume is V2, 5 mL≤V2≤20 mL; and
the third volume is V3, and 1 mL≤V3≤5 mL.

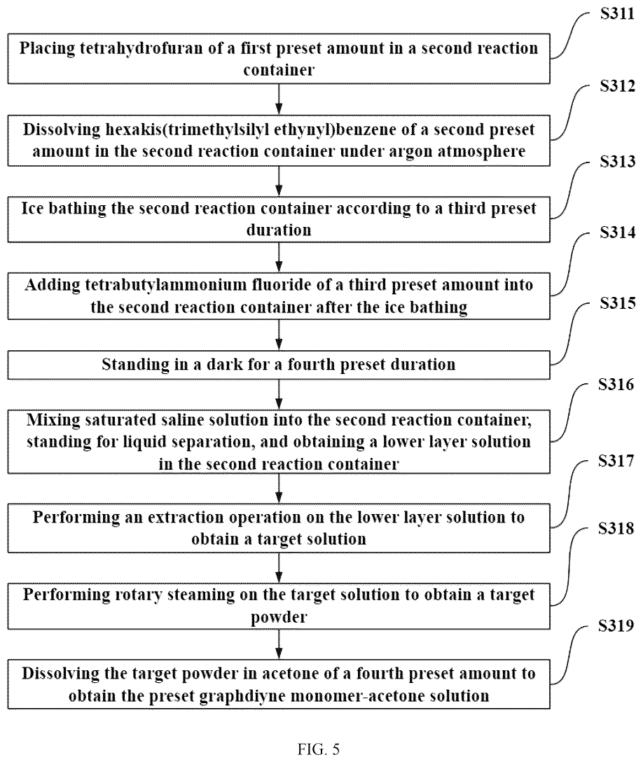

Referring to FIG. 5, a method for obtaining the preset graphdiyne monomer-acetone solution includes:
S311: placing tetrahydrofuran of a first preset amount in a second reaction container; in this embodiment, the second reaction container is preferably a three-necked flask;
the first preset amount is Q1, and 20 mL≤Q1≤40 mL;
in this embodiment, an amount of the tetrahydrofuran is preferably 40 mL;
S312: dissolving hexakis (trimethylsilyl ethynyl)benzene of a second preset amount in the second reaction container under an argon atmosphere;
and the second preset amount is Q2, and 1 mg≤Q2≤40 mg;
in this embodiment, an amount of the hexakis (trimethylsilyl ethynyl)benzene is preferably 1 mg;
S313: ice bathing the second reaction container according to a third preset duration; where the third preset duration is t3, and 10 min≤t3≤30 min;
in this embodiment, a duration of the ice bathing is preferably 10 min.
through this step, the reaction rate or temperature may be effectively controlled;
S314: adding tetrabutylammonium fluoride of a third preset amount into the second reaction container after the ice bathing;
where the third preset amount is Q3, and 0.5 mL≤Q3≤2 mL;

In this embodiment, an amount of the tetrabutylammonium fluoride is preselected to be 1 milliliter (mL);
a concentration of tetrabutylammonium fluoride is 1 mole per liter (mol/L) in tetrahydrofuran solution;
S315: standing in a dark for a fourth preset duration;
the fourth preset duration is t4, and 10 min≤t4≤15 min.
in this embodiment, the fourth preset duration is preferably 10 min;
S316: mixing saturated saline solution into the second reaction container, standing for liquid separation, and obtaining a lower layer solution in the second reaction container;
specifically, a concentration of the saturated salt solution is greater than a saturation wt 26.5%, with salt appearing to be optimal;
S317: performing an extraction operation on the lower layer solution to obtain a target solution;
specifically, the lower layer solution is taken and the extracting is repeated for three times; S318: performing rotary steaming on the target solution to obtain a target powder;
specifically, the target solution is subjected to rotary steaming by a rotary evaporator, and after a period of time, the target powder is obtained; in this embodiment, the target powder is light yellow powder; and
S319: dissolving the target powder in acetone of a fourth preset amount to obtain the preset graphdiyne monomer-acetone solution;
in this step, acetone is used to dissolve the target powdered material (i.e., the graphdiyne monomer HEB); it is necessary to use acetone in this case because no heterogeneous groups will be introduced by using acetone, and ethanol should not be used to avoid other side reactions;
where the fourth preset amount is Q4, and 30 mL≤Q4≤60 mL; and in this embodiment, an amount of the acetone is preferably 50 mL.

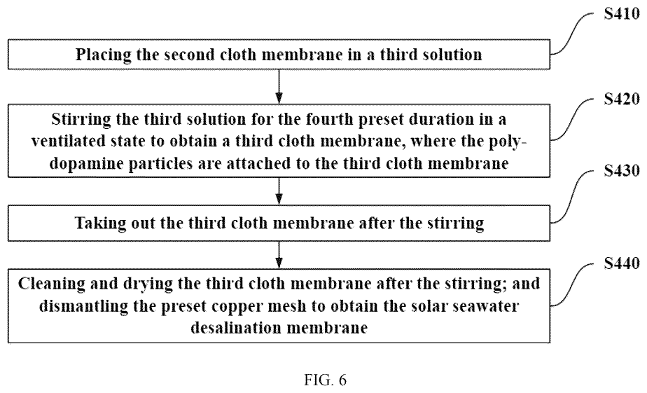

Referring to FIG. 6, a method for processing the second cloth membrane specifically includes:
S410: placing the second cloth membrane in a third solution;
where the third solution includes dopamine hydrochloride and Tris-hydrochloric acid buffer solution;
optionally, an amount of the dopamine hydrochloride is 80 mg, an amount of Tris-hydrochloric acid buffer solution is 40 mL, with a concentration of 1 mol/L;
S420: stirring the third solution for the fourth preset duration in a ventilated state to obtain a third cloth membrane, where the poly-dopamine particles are attached to the third cloth membrane;
specifically, the stirring is fully stirring on a magnetic stirrer at the speed of 800 rpm for 24 h, with ventilation maintained at all times so as to allow sufficient exposure of oxygen to the dopamine to oxidize and polymerize the dopamine to poly-dopamine (PDA).
the fully stirring in this step helps ensure that the components in the solution are in uniform contact with the cloth membrane, and the reaction may be fully carried out; S430: taking out the third cloth membrane after the stirring; and
S440: cleaning and drying the third cloth membrane after the stirring; and dismantling the preset copper mesh to obtain the solar seawater desalination membrane.

Among them, the deionized water and ethanol are used for washing to remove inorganic and organic impurities respectively, and after washing, drying treatment is carried out, and the obtained solar seawater desalination membrane is a photothermal seawater desalination membrane graphdiyne/PDA@CF based on carbon cloth/graphdiyne nano-wall/poly dopamine.

The second cloth membrane after the stirring is washed to remove unreacted material, solvents or other impurities to ensure a clean and stable membrane.

Poly-dopamine is further deposited and grown on the graphdiyne nano-wall. Poly-dopamine has extensive light absorption and remarkable photothermal conversion performance, and adsorbs heavy metal ions.

Further, the carbon cloth is sized to match the mouth of the three-necked flask, and the carbon cloth loaded with copper mesh is placed through the mouth of the flask without bending the carbon cloth so as to avoid affecting the quality of the graphdiyne grown into graphdiyne within the graphdiyne monomer surface. If the mouth of the three-necked flask for the reaction is enlarged, the size of the carbon cloth may also be enlarged to make a large-area desalination membrane.

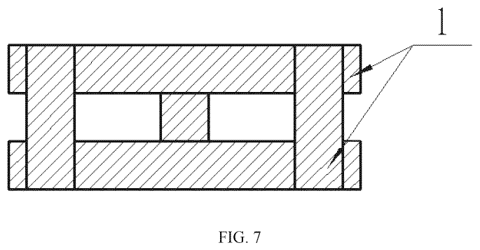

Referring to FIG. 7, in this application, the first carbon cloth, as the bottom carbon cloth, has a macroporous structure, and in practical application, as the side in contact with water, it can provide strong water conveyance; the second carbon cloth obtained through the treatment has greater hydrophilicity, and the hydrophilic effect is ensured to be within a preset range.

The second carbon cloth is composed of a plurality of fibrous structures 1, and the average pore size on the carbon cloth is of micron-scale.

It should be noted that the schematic diagram in this application is only a partial schematic diagram.

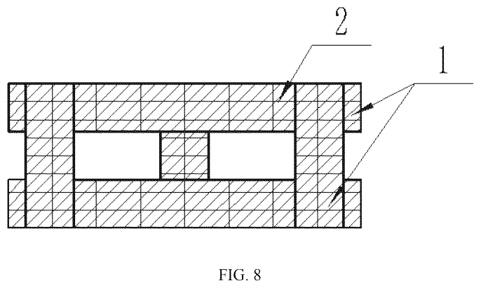

Referring to FIG. 8, the wrapping of the second carbon cloth 1 by the preset copper mesh 2 provides both a source of copper and facilitates ease of handling in the preparation of the desalination membrane.

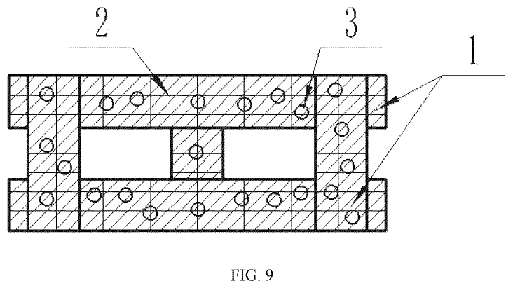

Referring to FIG. 9, the second cloth membrane obtained by processing includes graphdiyne structure 3, that is, graphdiyne nano-walls are grown on the second cloth membrane, and the holes of graphdiyne nano-walls are smaller, so that heat may be localized in the material.

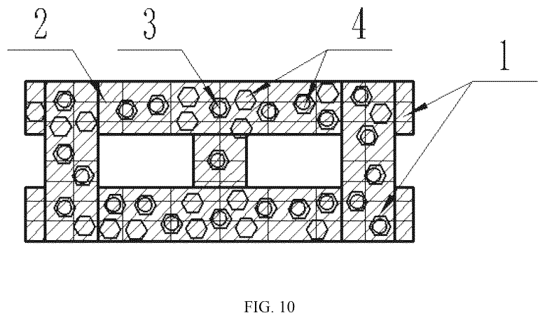

Referring to FIG. 10, on the third cloth membrane obtained by processing, there are poly-dopamine particles 4 growing on it, and further, several poly-dopamine particles are attached to the graphdiyne nanosheets in the graphdiyne structure 3, and at the same time, there are also poly-dopamine particles attached to the cloth membrane body.

The solar seawater desalination membrane obtained through treatment contains poly-dopamine particles, which form the third kind of holes, and the overall average pore diameter is smaller. PDA (poly-dopamine) micro/nano-spheres contain a large number of groups such as amino groups and phenolic groups, which may interact with water, and may also combine with metal ions to purify seawater to obtain fresh water, thus effectively solving the problem that the existence of heavy metal salt ions will reduce the stability of the evaporator and pollute the quality of produced water in the process of seawater desalination and wastewater treatment, suggesting an expanded application in the field of seawater desalination.

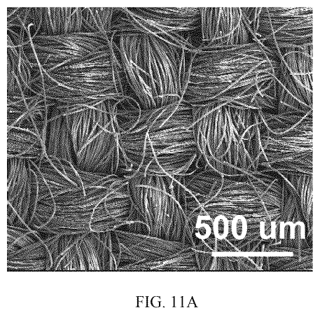

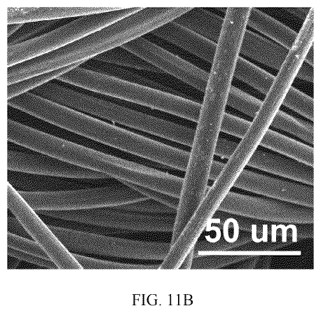

Further, referring to FIG. 11A and FIG. 11B, it may be clearly seen from the electron microscope images under different magnifications that the fibers in the second carbon cloth (i.e. hydrophilic carbon cloth CF) are smooth and straight, with obvious hole gaps of about 5 μm-10 μm, which provide a large number of channels for water transmission.

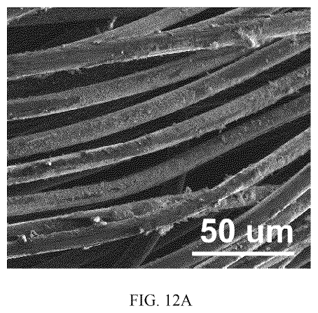

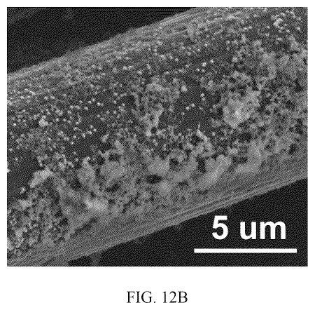

Referring to FIG. 12A and FIG. 12B, according to the electron microscope images under different magnifications, it can be clearly seen that the hydrophilic modified carbon cloth graphdiyne CF (i.e. the second cloth membrane) with graphdiyne wall (i.e. graphdiyne structure) grows, and it is observed that the graphdiyne is obviously attached to the carbon cloth fiber, and the pore size of graphdiyne is 50 nm-100 nm.

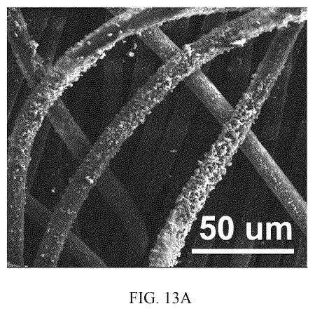

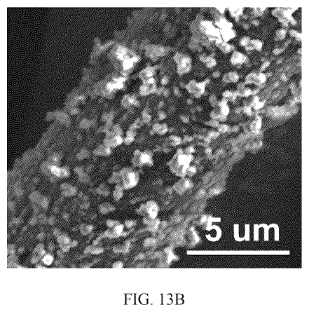

Referring to FIG. 13A and FIG. 13B, based on the electron micrographs at different magnifications, it is evident that the graphdiyne/PDA@CF grown with polydopamine (PDA) particles, i.e., the solar seawater desalination membranes obtained by the method disclosed in the present application, has spherical PDAs closely contacted to form the particles, with extremely small holes, which are less than 50 nm in this embodiment, meaning that the polydopamine is successfully adhered to the carbon cloth and the graphdiyne wall.

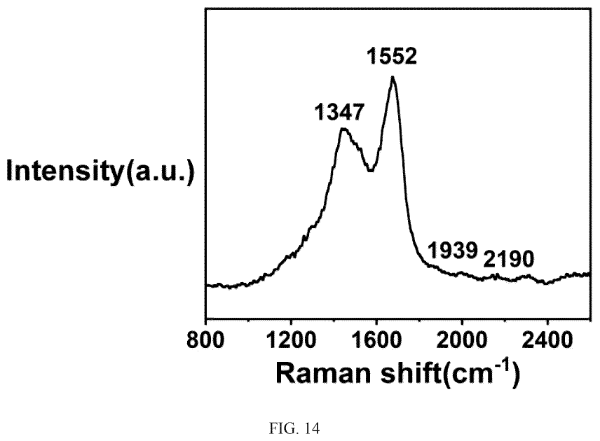

Further, with reference to FIG. 14, carbon cloth graphdiyne@CF (i.e. the second cloth membrane) attached with graphdiyne is tested by Raman spectroscopy at room temperature with 532 nm laser excitation, and the results show that the graphdiyne@CF has four peak positions, which are 1347 cm⁻¹, 1552 cm⁻¹, 1939 cm⁻¹ and 2190 cm⁻¹, respectively, which are consistent with Raman spectroscopy peak positions demonstrated in the literature related to graphdiyne, indicating that the structure of graphdiyne has been successfully grown and the structure has not been damaged.

TABLE 1

| | | | | Graphdiyne/ |
|---|---|---|---|---|
| Materials | CF | Graphdiyne@CF | PDA@CF | PDA@CF |
| Thermal | 0.5348 | 0.4057 | 0.5172 | 0.4379 |
| conductivity | | | | |
| (W/m/K) | | | | |

Table 1 shows the thermal conductivity of different materials measured by the transient plane source method through the second carbon cloth (i.e. hydrophilic carbon cloth CF),

Table 1 shows the thermal conductivity tests of different materials through the second carbon cloth (i.e., hydrophilic carbon cloth CF), hydrophilic modified carbon cloth with graphdiyne walls grown graphdiyne@CF (i.e., the second cloth membrane), and solar seawater desalination membranes obtained from the preparation measured using the transient plane source method, which reveals that the thermal conductivity of the carbon cloth CF after being made hydrophilic is 0.5348 (W/m/K).

After graphdiyne is successfully attached, the thermal conductivity of graphdiyne@CF is greatly reduced to 0.4057 (W/m/K), whereas the thermal conductivity of carbon cloth after attachment of only polydopamine is 0.5172 (W/m/K).

The thermal conductivity of graphdiyne/PDA@CF is reduced to 0.4379 (W/m/K), which shows that the thermal conductivity of carbon cloth after introducing graphdiyne/PDA is obviously lower than that of pure carbon cloth. The low thermal conductivity inhibits heat loss and improves the steaming performance.

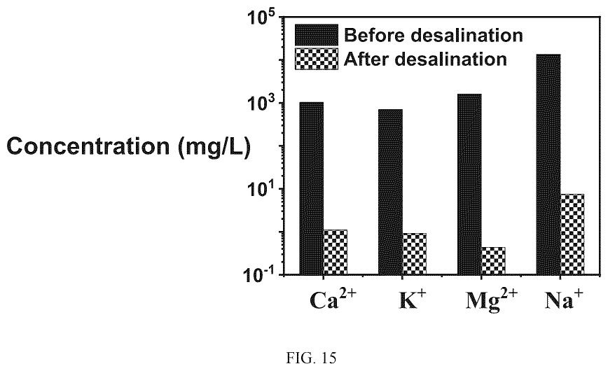

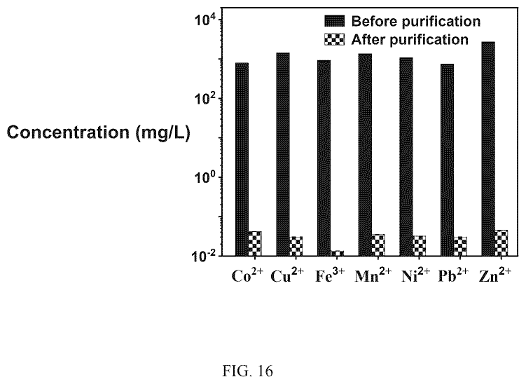

Referring to FIG. 15 and FIG. 16, simulated seawater and heavy metal wastewater are respectively evaporated by graphdiyne/PDA@CF (solar seawater desalination membrane prepared in this application) under a simulated sunlight environment, and condensed water is collected.

After testing the ion concentrations of the water body before and after the evaporation, it is found that the concentrations of K⁺, Ca²⁺, Na⁺ and Mg²⁺ in the simulated seawater are decreased greatly, the concentrations of Mn²⁺, Fe³⁺, Co²⁺, Ni²⁺, Cu²⁺, Zn²⁺ and Pb²⁺ in the heavy metal wastewater are also decreased greatly, indicating that graphdiyne/PDA@CF evaporator has high seawater desalination performance and heavy metal wastewater purification capacity.

TABLE 2

| | | | Graph- | | Graphdiyne/ |
|---|---|---|---|---|---|
| Materials | Water | CF | diyne@CF | PDA@CF | PDA@CF |
| Water | 0.52 | 1.26 | 2.25 | 2.51 | 2.83 |
| evaporation | | | | | |
| rate | | | | | |
| (kg/m²/h) | | | | | |
| Photothermal | 35.2 | 69.1 | 83.6 | 88.5 | 92.1 |
| conversion | | | | | |
| efficiency | | | | | |
| (%) | | | | | |

Table 2 shows the evaporation rates and photothermal conversion efficiencies of different materials (pure water, hydrophilic modified carbon cloth CF, carbon cloth graphdiyne@CF grown with graphdiyne, carbon cloth PDA@CF grown with poly-dopamine, and carbon cloth graphdiyne/PDA@CF with graphdiyne grown firstly and polydopamine grown secondly) under one solar irradiance.

According to Table 2, the change rate (i.e. water vaporization rate) of the water quality of hydrophilic carbon cloth CF is 1.26 kilograms per square meter per hour (kg/m²/h) under one solar irradiance. The vaporization rate of graphdiyne@CF is increased to 2.25 kg/m²/h after the introduction of only graphdiyne, which is attributed to the increased photothermal capacity due to the attachment of graphdiyne, and the reduced heat loss; the water vaporization rate of PDA@CF increases to 2.51 kg/m²/h after the introduction of PDA only, which is attributed to the fact that polydopamine dramatically increases the photothermal production capacity of the carbon cloth and increases the bottom-up replenishment of water; and the graphdiyne/PDA@CF grown with graphdiyne first followed by PDA has the most excellent water vaporization rate of 2.83 kg/m²/h, which is attributed to the synergistic increase in the photothermal capacity of the carbon cloth by the graphdiyne and PDA, which reduces the heat loss and enlarges the water transport capacity.

In addition, as shown in Table 2, the photothermal conversion efficiency of CF is 69.1% under one solar illumination, and the photothermal capacity of carbon cloth will be greatly increased by only introducing graphdiyne or PDA, which are 83.6% and 88.5% respectively. Moreover, the photothermal conversion efficiency of graphdiyne/PDA@CF that grows graphdiyne first and then PDA is the highest, reaching 92.1%, where graphdiyne and PDA synergistically increase the photothermal capacity of the carbon cloth and promote the evaporation of water, which verifies that the solar seawater desalination membranes obtained by the present application are capable of solving the problems of the prior art.

According to the method disclosed in the present application, on the one hand, carbon cloth, graphdiyne nano-walls and polydopamine are all used as black carbon-based materials with high near-infrared light absorption due to molecular thermal vibrations and have very high photothermal conversion efficiencies, thus this composite offers the potential to be used as a photothermal conversion material for solar desalination.

On the other hand, a secondary pore graphdiyne nano-wall structure is introduced to reduce the dissipation of heat to the water body below. Meanwhile, the graphdiyne itself has a low thermal conductivity, which inhibits the dissipation of heat to the outside body of water, thus concentrating the heat on the evaporating surface and exhibiting a high thermal localization effect.

On another hand, hydrophilic modification of the carbon cloth in this method produces rapid water diffusion, and the strong capillary effect achieves rapid replenishment of the heated top surface, preventing salt crystallization from obstructing the water channel; and the adsorption of heavy metal ions by polydopamine is utilized to improve the rate of vapor generation and evaporator stability.

In addition, extraction 3 times in this embodiment refers to a repeated process of separating the target substance from the initial phase as follows:
1. initial phase: placing the initial phase in which the target substance is located into a container, where this initial phase may be a liquid solution in which the target substance is mixed with other components;
2. addition of extractant: adding an extractant which selectively reacts with the target substance or separates it from other components, where the selection of the extractant is based on the properties of the target substance and the desired separation;
3. mixing and separation: mixing the initial phase with the extractant, whereby the target substance is transferred from the initial phase to the extractant by means of stirring or shaking;
4. phase separation: waiting for sufficient time for the two phases to separate, in which case the target substance will be distributed between the two phases as a result of the difference in their density or phase solubility;
5. separation of extractive phase: separating the two phases, usually through the use of tools such as a dispensing funnel or centrifuge, and the target substance usually remains in the extractive phase; and
6. repetition of steps 2 to 5: using the obtained extraction phase as the initial phase for the next extraction, repeating the above steps until the desired purity or extraction efficiency of the target substance is met.

The target substance is gradually increased in purity and separated from the initial phase by means of several extractions. The exact process depends on the target substance and the extraction method used. In different applications and experiments, different times of extraction and processing conditions may be used.

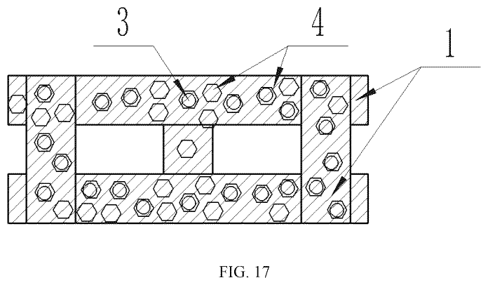

Referring to FIG. 17, another aspect of the present application discloses a solar seawater desalination membrane, which specifically includes:
carbon cloth, where the carbon cloth is composed of a plurality of fibrous structures 1, and an average pore size of the carbon cloth is of micron-scale;
graphdiyne structure 3 attached to one side of the carbon cloth, where the graphdiyne structure includes a plurality of graphdiyne nanosheets interwoven with each other, and an average pore size of the graphdiyne structure is of nanometer-scale; and
a plurality of poly-dopamine particles 4 attached to the graphdiyne nanosheets;
an average pore size of the poly-dopamine particles is of nano-scale, and the average pore size of the poly-dopamine particles is smaller than the average pore size of the graphdiyne structure.

The carbon cloth of the solar seawater desalination membrane provided by the application has an average pore size of micron-scale, which may effectively isolate solid particles and large particles, improve the filtration efficiency of the membrane, and provide strong water transportation at the same time; the graphdiyne structure with a nano-scale average pore size is helpful to filter the tiny particles and impurities in water more finely, improve the purification effect of seawater desalination, and at the same time, localize the heat in the material; and poly-dopamine particles are attached to graphdiyne nanosheets, which helps to increase the adsorption capacity of the membrane. PDA micro/nanospheres contain a large number of groups such as amino groups and phenolic groups, which may interact with water and combine with metal ions to purify seawater to obtain fresh water, thus effectively solving the problem that the existence of heavy metal salt ions will reduce the stability of evaporators and pollute the quality of produced water in the process of seawater desalination and wastewater treatment, and expanding the application in the field of seawater desalination.

Among them, the carbon cloth is carbon cloth after hydrophilic modification, that is, this carbon cloth is the second carbon cloth in the preparation method of solar seawater desalination membrane disclosed in an aspect of this application.

Among them, the poly-dopamine particles have a spherical structure.

Another aspect of the application discloses a preparation method of the solar seawater desalination membrane, which specifically includes the following steps:
obtaining a carbon cloth, where the carbon cloth is a hydrophilic modified carbon cloth, and an average pore size of the carbon cloth is of micron-scale;
coating the carbon cloth based on a preset copper mesh to obtain a first cloth membrane; and
growing graphdiyne nanostructures on the carbon cloth coated with copper mesh, namely processing the first cloth membrane to obtain a second cloth membrane, where the second cloth membrane includes a graphdiyne structure and the second cloth membrane has an average pore size of nanometer-scale.

Optionally, the graphdiyne structure includes a plurality of graphdiyne nanosheets interwoven with each other, and the plurality of graphdiyne nanosheets are interwoven with each other in three dimensions to form a three-dimensional graphdiyne structure.

Polydopamine particles are grown on the graphdiyne nanolayers; that is, the second fabric membrane is processed to obtain a solar seawater desalination membrane; the solar seawater desalination membrane includes polydopamine particles and the average pore size of the solar seawater desalination membrane is smaller than the pore size of the second cloth membrane.

In another aspect, the application discloses a seawater desalination treatment method, which adopts the solar seawater desalination membrane or the solar seawater desalination membrane prepared by the preparation method of the solar seawater desalination membrane to carry out seawater desalination treatment.

Specifically, the solar desalination membrane is placed above the seawater, which is capable of floating by itself on the surface of the water due to the low density of the membrane. Under the irradiation of sunlight, the desalination membrane absorbs the sunlight and converts it into heat energy to heat the surface water for evaporation, in this process, water vapor is generated at the water-air interface at a lower temperature and pressure, which is subsequently condensed and recovered to obtain the desalinated fresh water.

A detailed description of this embodiment may be found in the corresponding description in the preceding embodiments and will not be repeated herein.

The above describes the basic principles of the present disclosure in conjunction with specific embodiments; however, it should be noted that the advantages, benefits, effects, and the like mentioned in the present disclosure are merely exemplary rather than limiting, and are not to be regarded as necessary for the various embodiments of the present disclosure. Furthermore, the specific details disclosed above are for the purpose of exemplification and ease of understanding only, and are not limiting, and the above details do not limit the present disclosure as having to be realized using the above specific details.

Also, as used herein, the use of “or” in an enumeration of terms beginning with “at least one” indicates a separate enumeration so that, for example, an enumeration of “at least one of A, B, or C” means A or B or C, or AB or AC or BC, or ABC (i.e., A and B and C). Furthermore, the wording “exemplary” does not imply that the described embodiments are preferred or better than other embodiments.

It should also be pointed out that in the system and method of the present disclosure, components or steps may be decomposed and/or recombined. These decomposition and/or recombination should be regarded as equivalent schemes of the present disclosure.

The above description of the disclosed aspects is provided to enable any person skilled in the art to make or use the present disclosure. Various modifications of these aspects will be obvious to those skilled in the art, and the general principles defined herein may be applied to other aspects without departing from the scope of this disclosure. Therefore, the present disclosure is not intended to be limited to the aspects shown herein, but is to be accorded the widest scope consistent with the principles and novel features disclosed herein.

The foregoing description has been presented for purposes of illustration and description. Furthermore, this description is not intended to limit the embodiments of the present disclosure to the forms disclosed herein. Although several example aspects and embodiments have been discussed above, those skilled in the art will recognize certain variations, modifications, changes, additions and subcombinations thereof.

1. A preparation method of a solar seawater desalination membrane, comprising:
carrying out a hydrophilic treatment on a first carbon cloth to obtain a second carbon cloth, wherein a hydrophilicity of the second carbon cloth is greater than a hydrophilicity of the first carbon cloth, and an average pore size of the second carbon cloth is of micron-scale;
carrying out a coating treatment on the second carbon cloth based on a preset copper mesh to obtain a first cloth membrane comprises:
carrying out electrochemical polishing on the preset copper mesh;
cleaning the preset copper mesh after the polishing;
drying the preset copper mesh after the cleaning under a nitrogen flow; and
coating the preset copper mesh after the drying on either side of the second carbon cloth to obtain the first cloth membrane;
processing the first cloth membrane to obtain a second cloth membrane, wherein the second cloth membrane comprises a graphdiyne structure grown on one side, and an average pore size of the second cloth membrane is of nanometer-scale; and
processing the second cloth membrane to obtain the solar seawater desalination membrane;
wherein the solar seawater desalination membrane comprises poly-dopamine particles adhered to the graphdiyne structure, and an average pore size of the solar seawater desalination membrane is smaller than the average pore size of the second cloth membrane;
wherein the processing the first cloth membrane to obtain the second cloth membrane comprises:
obtaining a preset graphdiyne monomer-acetone solution;
putting a second solution into a first reaction container, wherein the second solution comprises acetone, pyridine and N,N,N′,N′-tetramethylethylenediamine;
placing the first cloth membrane in the second solution;
dropping the preset graphdiyne monomer-acetone solution into the second solution at a preset flow rate under a preset condition;
standing for a second preset duration according to a preset temperature to obtain a graphdiyne cloth membrane;
taking out the graphdiyne cloth membrane and cleaning the graphdiyne cloth membrane in a preset state; and
drying the graphdiyne cloth membrane after the cleaning under a nitrogen flow to obtain the second cloth membrane;
wherein a method for obtaining the preset graphdiyne monomer-acetone solution comprises:
placing tetrahydrofuran of a first preset amount in a second reaction container;
dissolving hexakis (trimethylsilyl ethynyl)benzene of a second preset amount in the second reaction container under an argon atmosphere;
ice bathing the second reaction container according to a third preset duration;
adding tetrabutylammonium fluoride of a third preset amount into the second reaction container after the ice bathing;
standing in a dark for a fourth preset duration;
mixing saturated saline solution into the second reaction container, standing for liquid separation, and obtaining a lower layer solution in the second reaction container;
performing an extraction operation on the lower layer solution to obtain a target solution;
performing rotary steaming on the target solution to obtain a target powder; and
dissolving the target powder in acetone of a fourth preset amount to obtain the preset graphdiyne monomer-acetone solution.

2. The preparation method of the solar seawater desalination membrane according to claim 1, wherein the carrying out the hydrophilic treatment on the first carbon cloth to obtain the second carbon cloth comprises:
placing the first carbon cloth in a cleaning solution, and performing ultrasonic cleaning for a first preset duration;
carrying out a hydrophilic treatment on the first carbon cloth after the ultrasonic cleaning by adopting a first solution; and
washing the first carbon cloth after the hydrophilic treatment in deionized water and carrying out a drying treatment to obtain the second carbon cloth.

3. (canceled)

4. The preparation method of the solar seawater desalination membrane according to claim 1, wherein the processing of the second cloth membrane to obtain the solar seawater desalination membrane comprises:
placing the second cloth membrane in a third solution;
wherein the third solution comprises dopamine hydrochloride and a buffer solution;
stirring the third solution for the fourth preset duration in a ventilated state to obtain a third cloth membrane, wherein the poly-dopamine particles are attached to the third cloth membrane;
taking out the third cloth membrane after the stirring;
cleaning and drying the third cloth membrane after the stirring; and
dismantling the preset copper mesh to obtain the solar seawater desalination membrane.

5. A solar seawater desalination membrane prepared by the preparation method of the solar seawater desalination membrane according to claim 1, wherein the solar seawater desalination membrane comprises:
carbon cloth, wherein the carbon cloth comprises a plurality of fibrous structures, and an average pore size on the carbon cloth is of micron-scale;
graphdiyne structure, attached to one side of the carbon cloth, wherein the graphdiyne structure comprises a plurality of graphdiyne nanosheets interwoven with each other; and an average pore size of the graphdiyne structure is of nanometer-scale; and
a plurality of poly-dopamine particles attached to the graphdiyne nanosheets;
wherein an average pore size of the poly-dopamine particles is of nanometer-scale, and the average pore size of the poly-dopamine particles is smaller than the average pore size of the graphdiyne structure.

6. The solar seawater desalination membrane according to claim 5, wherein the carbon cloth is a hydrophilic modified carbon cloth.

7. The solar seawater desalination membrane according to claim 5, wherein the poly-dopamine particles have a spherical structure.

8. A seawater desalination treatment method, comprising using the solar seawater desalination membrane prepared by the preparation method of the solar seawater desalination membrane according to claim 1 to carry out seawater desalination treatment.
